(19) United States
(12) Patent Application Publication
(10) Pub. No.: US 2009/0109691 A1
(43) Pub. Date: Apr. 30, 2009

(54) BENT FIXING STRUCTURE FOR LIGHT EMITTING COMPONENT

(76) Inventor: Yung-Yi Chuang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/877,670

(22) Filed: Oct. 24, 2007

(51) Int. Cl. F21V 19/00

(52) U.S. Cl. 362/382

(57) ABSTRACT

A bent fixing structure for fixing at least one pin of a light emitting component, such as a light emitting diode (LED). The bent fixing structure has a fixing part and a bent installation part. The fixing part is connected to the pin, and is used for fixing the light emitting component on the bent fixing structure. The bent installation part is connected to the fixing part, and an included angle between the fixing part and the bent installation part is unequal to 180 degrees.

### BACKGROUND OF THE INVENTION

1. Field of the Invention

The present invention relates to an element for fixing a light emitting component, and more particularly, to a bent fixing structure having a fixing part and a bent installation part for a light emitting diode, where an included angle between the fixing part and the bent installation part is not equal to 180 degrees.

2. Description of the Prior Art

Since the light emitting diode (LED) started widespread commercial availability in the 1960s, it is everywhere in our daily life because of its characteristic long life, low power consumption, and low heat. For example, it can be utilized as an indicator light or a light source in all kinds of household appliances and instruments.

Fixing the LED by solder is a common way to mount it on a circuit board. For mounting the LED on the edge of the circuit board in a manner of bending the pins 90 degrees depending on the design requirement, the LED cannot be fixed on the edge due to the pin structure of the four-pin LED (i.e. a super flux LED). Thus, the flexibility of use for the super flux LED is greatly decreased.

### SUMMARY OF THE INVENTION

It is therefore one of the objectives of the present invention to provide a bent fixing structure, to solve the above-mentioned problem. According to the above-mentioned objective of the present invention, a bent fixing structure for fixing at least one pin of a light emitting component (e.g. a LED) is disclosed. The bent fixing structure comprises a fixing part and a bent installation part. The fixing part is connected to the pin and is utilized for fixing the light emitting component on the bent fixing structure. The bent installation part is connected to the fixing part, and an included angle between the fixing part and the bent installation part is not equal to 180 degrees.

According to the above-mentioned objective of the present invention, a bent fixing structure for fixing at least one pin of a light emitting component is also disclosed. The bent fixing structure comprises a fixing part and a bent installation part. The fixing part is connected to the pin and is utilized for fixing the light emitting component on the bent fixing structure. The fixing part has a protruding structure utilized for fixing a protrusion of the pin of the light emitting component. The bent installation part is connected to the fixing part and is utilized for installation of the light emitting component. There is an included angle between the fixing part and the bent installation part.

According to the above-mentioned objective of the present invention, a bent fixing structure for fixing at least one pin of a light emitting component is further disclosed. The bent fixing structure comprises a fixing part and a bent installation part. The fixing part is connected to the pin and is utilized for fixing the light emitting component on the bent fixing structure. The fixing part has a tube structure utilized for covering the pin of the light emitting component. The bent installation part is connected to the fixing part and is utilized for installing the light emitting component. There is an included angle between the fixing part and the bent installation part.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a bent fixing structure according to an embodiment of the present invention.

FIG. 2 is a perspective diagram illustrating the bent fixing structure shown in FIG. 1.

FIG. 3 is a perspective diagram illustrating the bent fixing structure shown in FIG. 1 mounted on a circuit board.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

Different features of the present invention are detailed as below in reference to the figures, and for convenience of explanation, the same elements in separate figures are indicated by the same reference numerals.

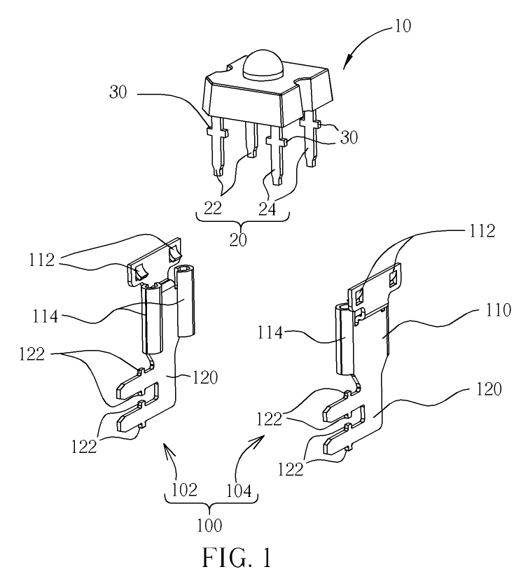

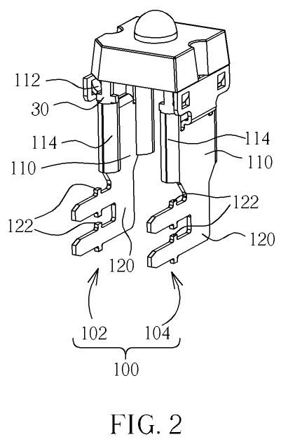

Please refer to FIG. 1 and FIG. 2 together. FIG. 1 and FIG. 2 are respectively a schematic diagram and a perspective diagram illustrating a bent fixing structure 100 according to a first embodiment of the present invention. As shown in FIG. 1 and FIG. 2, the bent fixing structure 100 comprises a left terminal 102 and a right terminal 104, and each terminal has a fixing part 110 and a bent installation part 120, respectively. The fixing parts 110 of the left terminal 102 and the right terminal 104 respectively connect to two pairs of pins 22 and 24 of the pins 20 of a light emitting component such as a light emitting diode (LED) 10, and are utilized to affix the light emitting diode 10 onto the bent fixing structure 100. In this embodiment, the light emitting diode 10 fixed in the bent fixing structure 100 is a super flux LED; this is merely for illustrative purposes, however, and is not meant to be a limitation of the present invention. In other words, the bent fixing structure disclosed by the present invention can be applied in various kinds of LEDs or light emitting components. In addition, the left terminal 102 and the right terminal 104 respectively connected to the two pairs of pins 22 and 24 of the light emitting diode 10, which is a super flux LED, correspond to two different polarities. For example, the pins connected to the left terminal 102 corresponds to a negative electrode (−), and the pins connected to the right terminal 104 corresponds to a positive electrode (+); but this is not meant to be a limitation of the present invention. The bent installation part 120 is connected to the fixing part 110, and there is an included angle between the fixing part 110 and the bent installation part 120, which is not equal to 180 degrees. The structure and operation of the bent fixing structure 100 will be detailed in the following.

Please refer to FIG. 1 and FIG. 2 again. As shown in FIG. 1 and FIG. 2, the fixing part 110 of the bent fixing structure 100 has a protruding structure 112 and a tube structure 114. When the light emitting diode 10 is affixed to the bent fixing structure 100, the protruding structure 112 is utilized to fix protrusions 30 on pins 20 of the light emitting diode 10, and the tube structure 114 is utilized to cover pins 20 of the light emitting diode 10. In this way, the light emitting diode 10 can firmly be affixed in the bent fixing structure 100. In this embodiment, the bent fixing structure 100 also has a protruding structure 112 and a tube structure 114; this is merely for illustrative purposes, however, and is not meant as a limitation of the present invention. In other embodiments, the bent fixing structure 100 can have only either a protruding structure 112 or a tube structure 114. These alternative designs can achieve the objective of affixing the light emitting diode 10 to the bent fixing structure 100. For example, the bent fixing structure can only have the tube structure (that is, without the protruding structure) and make use of only the tube structure to cover pins of the light emitting diode with no protrusions formed on the pins. Additionally, the bent fixing structure is electrically connected to pins of the light emitting diode only through the tube structure. This design modification also obeys the spirit of the present invention.

In addition, the fixing part 110 of the bent fixing structure 100 disclosed in the present invention is electrically connected to pins 20 of the light emitting diode 10 only through the protruding structure 112 and the tube structure 114; in other words, the light emitting diode 10 can still be affixed to the bent fixing structure 100 and be electrically connected to the bent fixing structure 100 without the need for extra conductive material such as solder with the intention of connecting the fixing part 110 to pins 20 of the light emitting diode 10.

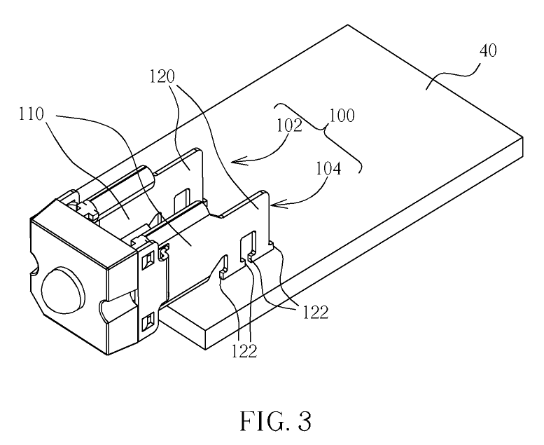

Please refer to FIG. 3. FIG. 3 is a perspective diagram illustrating the bent fixing structure 100 mounted on a circuit board 40. As shown in FIG. 3, in this embodiment, the included angle between the fixing part 110 and the bent installation part 120 is equal to 90 degrees; this is merely for illustrative purposes, however, and is not meant to be a limitation of the present invention. In other words, the above-mentioned included angle can be modified depending on design requirements. Thus, when it is intended to install a light emitting component (e.g., the light emitting diode 10) onto a target device (e.g., the circuit board 40) through the bent installation part 120, the light emitting surface of the light emitting component can be easily oriented to the desired direction in spite of the installed position by properly designing the included angle between the fixing part 110 and the bent installation part 120.

Moreover, as shown in FIG. 1 and FIG. 3, the bent installation part 120 of the bent fixing structure 100 has a plurality of protrusions 122 that restrict the distance between the light emitting diode 10 and the circuit board 40 when the bent installation part 110 is mounted on the circuit board 40. Thus, if many light emitting diodes are mounted onto the circuit board, the distance between each light emitting diode and the circuit board will be the same.

Compared with the prior art, in this embodiment, the bent fixing structure makes use of the fixing part to fix the light emitting diode in the bent fixing structure and utilize the bent installation part to install the bent fixing structure on the edge of the circuit board. The light emitting diode can therefore change its direction and be mounted onto the circuit board.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A bent fixing structure for fixing at least one pin of a light emitting component, comprising:
a fixing part, connected to the pin, for fixing the light emitting component on the bent fixing structure; and
a bent installation part, connected to the fixing part, for installation of the light emitting component, wherein an included angle between the fixing part and the bent installation part is unequal to 180 degrees.

2. The bent fixing structure of claim 1, wherein the light emitting component is a light emitting diode (LED).

3. The bent fixing structure of claim 2, wherein the LED is a super flux LED.

4. The bent fixing structure of claim 3, wherein the fixing part has a protruding structure for fixing a protrusion of the pin of the super flux LED.

5. The bent fixing structure of claim 4, wherein the fixing part is electrically connected to the pin only through the protruding structure.

6. The bent fixing structure of claim 4, wherein the fixing part further has a tube structure for covering the pin of the super flux LED.

7. The bent fixing structure of claim 6, wherein the fixing part is electrically connected to the pin only through the protruding structure and the tube structure.

8. The bent fixing structure of claim 3, wherein the fixing part has a tube structure for covering the pin of the super flux LED.

9. The bent fixing structure of claim 8, wherein the fixing part is electrically connected to the pin only through the tube structure.

10. The bent fixing structure of claim 2, wherein the fixing part has a tube structure for covering the pin of the LED.

11. The bent fixing structure of claim 10, wherein the fixing part is electrically connected to the pin only through the tube structure.

12. The bent fixing structure of claim 2, wherein the included angle is equal to 90 degrees.

13. The bent fixing structure of claim 2, wherein the bent installation part has a protrusion for restricting a distance between the LED and a circuit board when the bent installation part is mounted on the circuit board.

14. A bent fixing structure for fixing at least one pin of a light emitting component, comprising:
a fixing part, connected to the pin, for fixing the light emitting component on the bent fixing structure, wherein the fixing part has a protruding structure for fixing a protrusion of the pin of the light emitting component; and
a bent installation part, connected to the fixing part, for installation of the light emitting component, wherein there is an included angle between the fixing part and the bent installation part.

15. The bent fixing structure of claim 14, wherein the fixing part is electrically connected to the pin only through the protruding structure.

16. The bent fixing structure of claim 14, wherein the fixing part further has a tube structure for covering the pin of the light emitting component.

17. The bent fixing structure of claim 16, wherein the fixing part is electrically connected to the pin only through the protruding structure and the tube structure.

18. The bent fixing structure of claim 14, wherein the light emitting component is a light emitting diode (LED).

19. The bent fixing structure of claim 18, wherein the LED is a super flux LED.

20. A bent fixing structure for fixing at least one pin of a light emitting component, comprising:
a fixing part, connected to the pin, for fixing the light emitting component on the bent fixing structure, wherein the fixing part has a tube structure for covering the pin of the light emitting component; and
a bent installation part, connected to the fixing part, for installation of the light emitting component, wherein there is an included angle between the fixing part and the bent installation part.

21. The bent fixing structure of claim 20, wherein the fixing part is electrically connected to the pin only through the tube structure.

22. The bent fixing structure of claim 20, wherein the light emitting component is a light emitting diode (LED).

23. The bent fixing structure of claim 22, wherein the LED is a super flux LED.
